(19) United States
(12) Patent Application Publication
(10) Pub. No.: US 2015/0242468 A1
(43) Pub. Date: Aug. 27, 2015

(54) Nutritional Assessment Tool

(71) Applicants: James William Shoemaker, Dexter, IA (US); Mark Joseph Hoag, II, West Des Moines, IA (US)

(72) Inventors: James William Shoemaker, Dexter, IA (US); Mark Joseph Hoag, II, West Des Moines, IA (US)

(21) Appl. No.: 14/190,977

(22) Filed: Feb. 26, 2014

(51) Int. Cl. G06F 17/30; G06F 17/27

(52) U.S. Cl. CPC G06F 17/30528; G06F 17/2705

(57) ABSTRACT

The nutritional assessment tool allows a user to select from a recipe database, or enter a recipe of his own; the tool then parses the ingredients, searches other databases for nutrition profile information of each ingredient, and applies the profile to the amount of that ingredient called for in the recipe. It repeats for each ingredient and then provides a nutritional profile of the food item on a per serving basis. This may be applied to entire meals, as well. The tool can provide suggested replacement ingredients to allow the user to tailor his nutritional intake, will allow the user to store meal information and then generate reports related to nutritional profile of a food item, a meal, or a time frame.

### CROSS-REFERENCE TO RELATED APPLICATION

This application is a utility application of U.S. Provisional Application No. 61/770,004, which was filed with the U.S. Patent and Trademark Office on Feb. 27, 2013.

### FIELD OF INVENTION

The present invention relates to the health and/or fitness industry, more specifically, to the various means available for determining and tracking caloric and nutritional intake.

### BACKGROUND

In the United States and many other parts of the world, the time effort and money spent by consumers and businesses alike to improve fitness, health and nutrition represents a multi-million dollar industry. Products range from exercise equipment, to fitness centers, to clothing, to books and videos all aimed at assisting the user to determine and/or attain his fitness goals. Services run the gamut from fitness centers, classes tailored to specific goals or outcomes, personal coaches to educate and motivate, diet counselors and nutritionists to advise about inputs relative to the desired outputs, and pre-made meals and snacks carefully tailored to target particular nutritional and caloric targets.

Those with high blood pressure are advised to consume no more than 1,500 mg of sodium per day, and meet the potassium recommendation (4,700 mg/day) with food. For improving heart health, Mayo Clinic recommends limiting total daily fat to 44 to 78 g; limiting dietary cholesterol to between 200 mg and 300 mg a day; restricting saturated fat to between 16 and 22 g daily and trans fat to no more than 2 g per day. There are dozens of other recommendations for nutritional content related to many other health conditions. But making the recommendation is one thing; following it is quite another and can be relatively challenging.

Caloric value of a serving of something one makes at home is difficult to determine. There are some cookbooks that include calories per serving for a given recipe, but there is typically little or no other information available. There is scant available information, on a per serving basis, related to cholesterol, vitamins, protein, fat, dietary cholesterol, sodium, sugars, and various preservatives for recipes made at home. There are very few, if any, tools that provide means to determine these values, track the accumulated values for the intake of a given individual, or combine the label information on purchased foods with those made at home to provide a nutritional profile by the meal, the day, the week or other period of time. Yet, having this level of detail is necessary to fully take advantage of the knowledge base regarding the intersection between health and nutrition.

Those who wish to become fit, or maintain fitness are only one sector that can benefit from information related to nutritional profile and content in their diets. In addition to those who wish to become more fit, many others need or could benefit from such information if it were available. Those with any type of diabetes, high blood pressure, or heart problems, those with particular kinds of cancer, gall bladder problems, GERD, etc., would benefit as well as a host of others managing various health problems. Another possible use would be for parents wishing to balance a child's diet based on his or her age, sex, etc. and, alternatively, those managing the health of the aging would be able to benefit from this information. As additional information becomes available relating to the short term effects of, for example, anti-oxidants, it is entirely possible that an individual preparing, for example, for academic examination might design a diet based on such information in order to maximize her performance.

What was needed was a tool that is simple to use for assessing the nutritional profile for a serving of a particular dish. Such an assessment tool would be more useful if it could take into account the differing profiles of a particular ingredient based on brand name. Obtaining such an assessment in a way that is as highly automated as possible would be desirable, perhaps comprising a tool available on-line or, optionally employed by a program that includes features for storing nutritional profiles of an individual's consumption, or planned consumption. Further, an assessment tool comprising various databases related to certain health conditions and recommended nutritional profiles for each could be employed to assist the user in managing the nutritional profile of the intake of one who has such a condition.

### BRIEF DESCRIPTION OF THE DRAWINGS

FIG. 1 Process used by Nutritional Assessment Tool to create profile based on recipe.

FIG. 2 Continuation of FIG. 1 to create profile of intake over time.

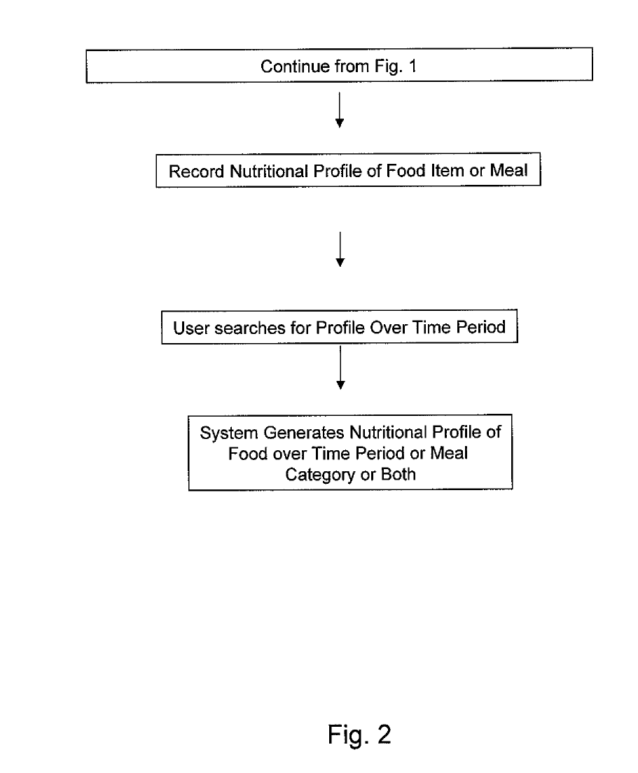

FIG. 3 Process used by Nutritional Assessment Tool to generate suggested recipes or meals based on target nutritional profile.

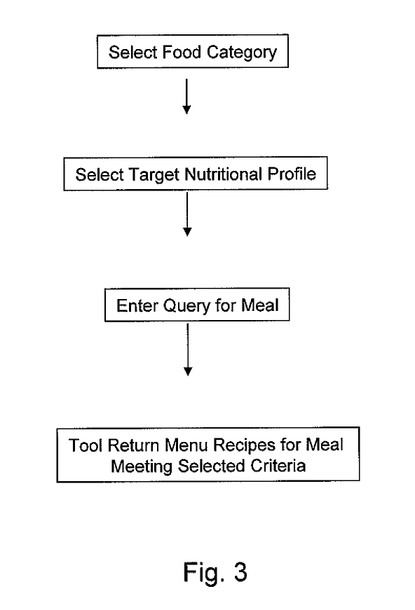

FIG. 4 Process used to convert a recipe to meet selected nutritional profile.

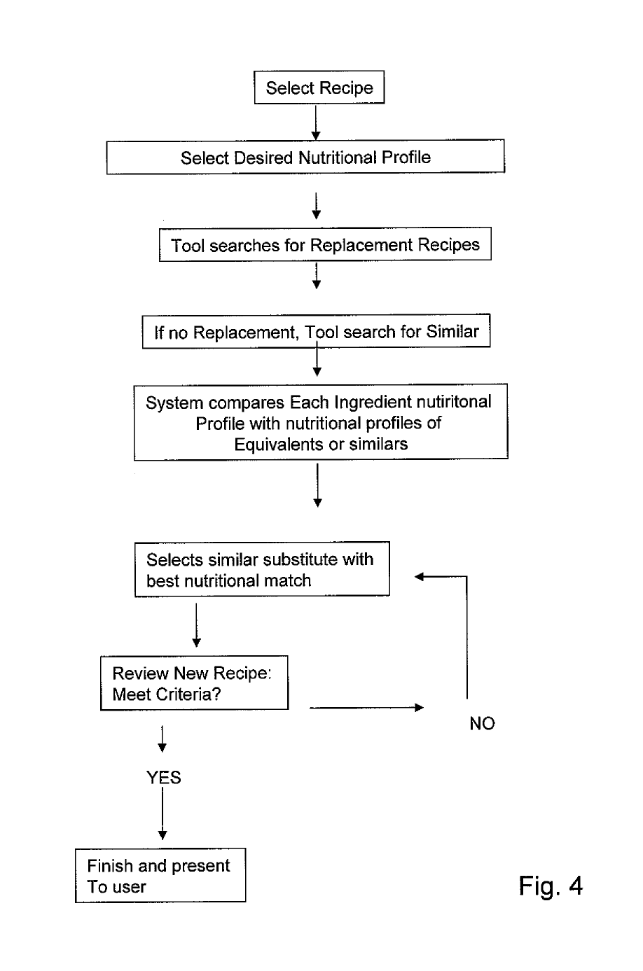

### SUMMARY OF THE INVENTION

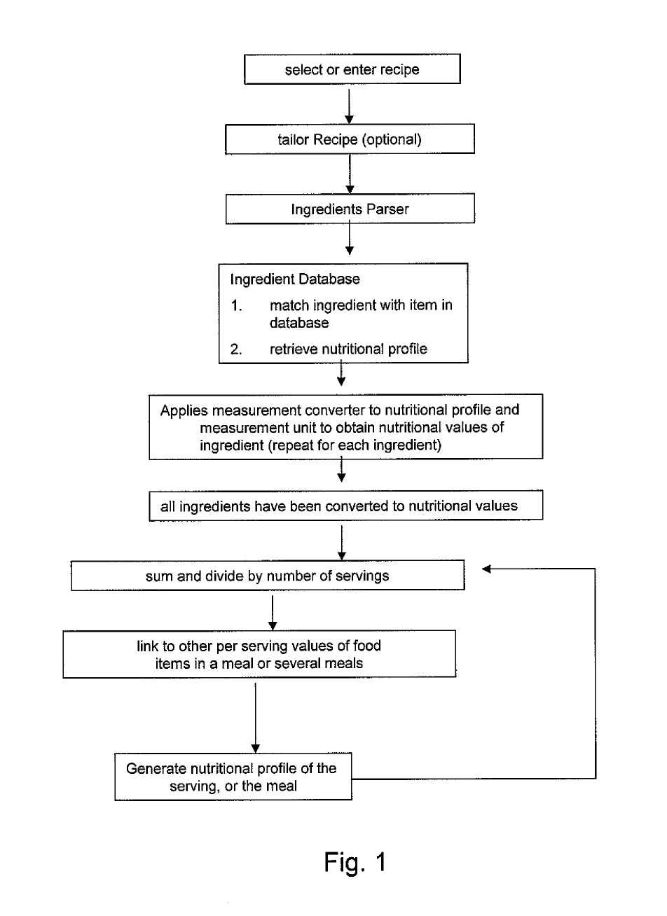

FIG. 1 is a flow chart showing one process used by the assessment nutritional tool. The present invention comprises a tool comprising software run on a microprocessor that can either access a number of databases specific to the tool or can search the interne for specified databases and selectively import data necessary to perform the tasks described herein, or the tool may include both capabilities i.e. come equipped with loaded databases as well as the ability to selectively obtain information from sources accessed via the internet such as the USDA food and ingredient databases. The tool includes a number of features related to nutrition profiling based on recipe input. The tool determines nutritional information based on a recipe i.e. the ingredient and the amount of the ingredient, and the number of servings the recipe will make in combination with known nutritional values associated with each ingredient which the tool accesses. The most intricate feature is a built-in nutrition calculator that allows the user or a health coach to add desired recipes to a meal plan or to a recipe folder and the system will automatically calculate the nutritional data, based on the entered ingredients. This level of sophistication allows users which include, but are not limited to, individuals, health coaches, institutional meal providers, or health care providers to create custom meal plans that fit within specific dietary guidelines, or to track nutritional intake and adjust to achieve an overall desired nutritional intake.

### DETAILED DESCRIPTION OF THE INVENTION

The present invention comprises a tool that may be described as a nutritional calculator. The nutritional calculator preferably includes or accesses a) an ingredient parser, b) a plurality of databases that include a nutritional profile database which includes profiles of ingredients based on a measurement c) and, perhaps, a recipes database, and d) a database of nutritional profiles of ingredients by brand name, e) a measurement converter, and f) a nutrition profile converter.

The nutritional profile database may include information provided by USDA databases, other public databases, or databases created for use by the nutritional calculator. The tool can provide the nutrition profile of a serving of any recipe in its database or that is input by a user. It is equipped with means to estimate where necessary, and to indicate if it does not have access to information pertaining to any particular ingredient, and to make reasonable substitutions of one particular brand of an ingredient for another brand of that same ingredient, and generating a warning of such substitution to the user.

The tool may be employed to generate a nutritional profile of a serving of a particular food, or a meal, provided all foods consumed with the meal are input. It may be employed to record nutritional profiles of food intake over the course of a day, a week or other time frame. It can be used to generate an alternative nutritional profile of a particular recipe in accordance with nutritional parameters selected by the user, such alteration in the form of suggestions for substitution ingredients by substance or brand.

The first step is for the user either to select a recipe that is already in the tool's recipe database, or to input a recipe that is not yet in the database. In a preferred embodiment, the recipe database is linked to a nutritional profile database that includes not only a generic name of each ingredient and a generic nutritional profile for that ingredient, but also at least one, and preferably more than one, brand name of that ingredient which is, in turn, linked to a nutritional profile of that Brand Name's version of that ingredient. Alternatively, a user may select the recipe from a database, and then edit it according to the Brand Names of ingredients the user employs, or may edit the recipe in accordance with the user's own preferences (e.g. an additional teaspoon of salt, or decrease the amount of cheese from 8 ounces to 6 ounces.)

Once the recipe is selected/entered, the tool uses the ingredient parser to read the recipe. The parser examines the ingredient lines from a recipe for conjunctives (e.g. “and”, “or”) and separates the ingredient line accordingly. “And”-type conjunctives result in multiple ingredients being added to the ingredient list for that line, “or”-type conjunctives are marked as being alternatives for the same ingredient. Within each part of the separated line (or the whole line, if no conjunctives were found), the parser looks for quantities, measurement units, and things that it has been programmed to recognize as definitely not ingredients. Whatever's left after identification of quantities, etc., is assumed to be the ingredient label. Quantity, measure, and the ingredient label are saved for later use by the Nutritional Calculator.

The Tool uses the data provided by the ingredient parser. For each ingredient label the tool employs an ingredient database which is akin to a standard product database looking for food items which are good matches for each ingredient label. This database may be incorporated into the tool, or it may be external to the tool and accessed via internet or similar connection. The tool links the ingredient label from the parsed recipe to the best matched food item which is, in turn, linked to a nutritional profile for that food item. If the user has associated a specific food item with a brand name, the tool uses data associated with that brand name of the food item. The nutritional profile for each food item is, preferentially, data provided by the USDA, or if the USDA data does not have a match, to food items in the tool's database.

Next, the Tool uses the measure from the ingredient line from which the ingredient label was identified (e.g., cup, ounce)—or if no standard measure was specified it assigns the most appropriate measure for the ingredient (e.g., a pinch of salt, or an average-sized apple)—and retrieves the nutritional profile from the database for that food item and assigns the specified measure to that food item. The tool then employs a measurement converter to convert the nutritional profile of the food item specified in the profile to a nutritional profile for the amount of that food item called for by the recipe. Specifically, the nutritional profile of the food item may provide the profile for a unit that is weight, volume, metric, English, etc. . . The measurement converter converts that measure to one that corresponds with or is compatible with the measurement provided by the recipe. If it finds a compatible measure, it gets the nutrition profile for that food item for that measure, and converts it to the nutritional value for the measure given in the recipe, taking the quantity provided by the ingredient parser into account. If no compatible measure is found, it repeats the process for the next most eligible ingredient, until it either finds a match or reaches the preset limit for iterations.

This iterative process is repeated for each ingredient found in the recipe. The nutritional values for each ingredient are summed, and then divided by the number of servings in the recipe, to find the per-serving nutrition for that recipe.

In another embodiment, food chemistry is incorporated in the calculation to account for things like alcohols or oils being cooked away, carmelization, and the Maillard reaction. In this embodiment, the parser recognizes words such as, but not limited to, “heat”, “boil”, “melt” and “sauté” and “carmelize” and applies the appropriate reduction or equation to determine the nutritional profile taking such processes into account.

Once the per serving nutritional profile is determined, the tool can be used combine the recipes for the other foods in a meal and link them together in the nutritional calculator as a meal; optionally, the system allows the user to link several meals together over time. In a preferred embodiment, the user will be able to use the tool to generate a nutritional profile for a variety of accumulated recipe groups. For example, based on recipes used for all meals for the previous week, a user may generate the nutritional profile, on average, of breakfast for a week, or lunch, or snacks, or for the week as a whole. In another embodiment, one would be able to select a category of food and ask the tool to generate a menu for a meal, within that category, that meets certain nutritional standards; for example, an Italian dinner having less than a specified amount of sodium and calories. The tool selects recipes categorized as Italian, then compares and combines per-serving nutritional profiles in conjunction with standard categories (e.g. salad, entré, bread, side dish) to create a combination in line with the desired nutritional standards.

Another embodiment includes a “recipe adjuster” tool which responds to a user's requests. For example, a user with low sodium diet needs may use the “recipe adjuster” to adjust the recipe of a particular food item to meet a particular level of sodium. The recipe adjuster employs in various combinations the nutritional profiles of substitute possible ingredients for one or more ingredients called for by the recipe to reduce sodium in the particular recipe by suggesting replacement ingredients and the correct amounts of such replacement. This same adjustment may be made for an entire meal by selecting the recipes together as a group and indicating a “not to exceed” sodium level or by selecting “reduce” and “sodium”.

The invention may be housed in a handheld device or device which can be worn by the user, equipped with means to use WiFi or similar means to access electronically available databases via an internet connection, or to access databases stored in a cloud computing environment. Alternatively, the invention may comprise downloadable software for use with any standard computing equipment and include databases or include access to databases that can be accessed via the internet or via cloud computing environment. The tool itself may remain resident in a cloud computing environment and accessed by a user's home computer or device such as an iPad, an iPhone, or other telephonic devices with internet access capabilities. It is also contemplated that a device housing the tool and a number of databases may be sold as a stand alone device, with the ability to cross-load data to a storage device as necessary.

The present invention has been described both broadly and in narrower terms. Many modifications and variations of the present invention are possible in light of the above teachings. Therefore, within the scope of the appended claims, the present invention may be practiced otherwise than as specifically described.

What I claim is:

1. A nutritional calculator for providing a nutritional profile comprising:
a) a recipe said recipe comprising a plurality of ingredients and a measure for each of substantially all of said plurality of ingredients,
b) at least one ingredient database;
c) a plurality of nutritional profiles each said profile electronically linked to one or more ingredients in said at least one ingredient database and expressed in profile units;
d) an ingredient parser for parsing said recipe to obtain each ingredient and each ingredient measure;
e) a measurement converter for converting said ingredient measure to said profile units, and
f) a nutrition profile generator for compiling the profile units of each said ingredient into a nutritional profile of said recipe.

2. The nutritional calculator of claim 1 further comprising a serving size, said serving size employed by the nutrition profile generator to generate a nutritional profile of a serving.

3. A nutritional calculator for determining the nutritional profile of at least one of a plurality of food items, wherein said calculator comprises an ingredient database; a plurality of nutritional profiles, each said profile linked to one or more ingredients in said ingredient database; a plurality of recipes each said recipe associated with a particular food item and comprising a plurality of ingredients and a measure required for at least one of said plurality of ingredients; said nutritional calculator determining the nutritional profile of said at least one of a plurality of food items by associating each of said plurality of ingredients in each recipe associated with each food item in said plurality of food items with the nutritional profile of said ingredient, applying the measure required for each said ingredient and generating a nutritional profile of said plurality of food items.

4. The nutritional calculator of claim 3 wherein at least one of said plurality of recipes includes a serving size, said serving size applied to generate a nutritional profile of said at least one of a plurality of food items per serving.

5. The nutritional calculator of claim 3 further comprising means to selectively indicate at least one nutritional profile requirement.

6. The nutritional calculator of claim 5 wherein said at least one nutritional profile requirement is selected from the group consisting of: sodium level, caloric value, sugar-related value, carbohydrate measure, protein measure.

7. The nutritional calculator of claim 5 further comprising a plurality of conversions for substitution of commonly employed ingredients, wherein said calculator applies said at least one nutritional profile requirement and employs at least one of said conversions to substitute one or more of said plurality of ingredients to achieve said nutritional profile requirement.

8. The nutritional calculator of claim 3 further comprising means to generate a meal menu in response to at least one of a plurality of selectable criteria, said meal menu comprising a recipe for each of a plurality of food items.

9. The nutritional calculator of claim 8 wherein said plurality of selectable criteria includes values pertaining to calories, sodium, sugar, proteins, fats, and carbohydrates.

10. The nutritional calculator of claim 8 wherein said plurality of selectable criteria includes ethnicity, level of formality, preparation difficulty, preparation time.

11. The nutritional calculator of claim 4, said calculator further comprising means to store the nutritional profile of each said serving of a plurality of meals.

12. The nutritional calculator of claim 11 further comprising means to generate an overall nutritional profile for a combination of servings of said plurality of meals.

13. The nutritional calculator of claim 12 wherein said overall nutritional profile includes data related to at least one of the group consisting of: sodium, calories, protein, fat, carbohydrate, and sugar.

14. The nutritional calculator of claim 12 wherein said overall nutritional profile includes data related to at least one of a plurality comprising sodium, calories, protein, fat, carbohydrate and sugar.
